(19) United States
(12) Patent Application Publication
(10) Pub. No.: US 2011/0052845 A1
(43) Pub. Date: Mar. 3, 2011

(54) METHOD FOR PRODUCING A HOLLOW BODY

(75) Inventors: HEINRICH DERMOND, Wien (AT); Daniela Dermond-Forstner, Wien (AT)

(73) Assignee: Dermond-Forstner & Sreboth OG, Vienna (AT)

(21) Appl. No.: 12/855,109

(22) Filed: Aug. 12, 2010

Related U.S. Application Data
(60) Provisional application No. 61/233,631, filed on Aug. 13, 2009.

(30) Foreign Application Priority Data
Aug. 12, 2009 (EP) 09450149.1

(51) Int. Cl. B64C 1/00; B32B 37/12; B05C 3/12; B32B 38/18

(52) U.S. Cl. 428/34.1; 156/185; 118/428; 118/423

(57) ABSTRACT

In a method for producing a hollow body—implemented as a sandwich construction—in particular an aircraft fuselage, an inner layer is formed from a specifiable number of plies of a specifiable at least resin-wetted fiber material, for simple, rapid, and cost-effective formation of a large-volume cavity, which has a low weight and a high mechanical carrying capacity in relation to its size. At least a first ply of the inner layer has a helical configuration and is configured without interruption essentially over an entire length of the hollow body.

### CROSS-REFERENCES TO RELATED APPLICATIONS

This application claims the benefit of prior filed U.S. Provisional Application No. 61/233,631, filed Aug. 13, 2009, pursuant to 35 U.S.C. 119(e).

This application also claims the priority of European Patent Application Serial No. 09450149.1, filed Aug. 12, 2009, pursuant to 35 U.S.C. 119(a)-(d).

The contents of U.S. Provisional Application No. 61/233,631 and European Patent Application Serial No. 09450149.1 are incorporated herein by reference in their entireties as if fully set forth herein.

### BACKGROUND OF THE INVENTION

The present invention relates, in general, to a method for producing a hollow body, implemented as a sandwich construction.

The following discussion of related art is provided to assist the reader in understanding the advantages of the invention, and is not to be construed as an admission that this related art is prior art to this invention.

Producing aircraft fuselages, which are particularly preferably hollow bodies in the meaning of the present invention, from or comprising composite materials is known. It is typical to manufacture the aircraft fuselages in parts, typically annular segments, in the so-called parallel layer method. In this case, individual mats or webs of a fiber material, which is impregnated with artificial resin, are laminated over a form. This has the disadvantage that the individual fiber strands of the fiber material only run around the periphery of the aircraft fuselage once, and overlap in a narrow area. Fiber composite materials have the property that their capability of absorbing or transmitting forces is essentially a function of the course and the integrity of the individual fibers. In order to achieve good strength in many directions, a fiber material in the form of a so-called multi-axle fabric is therefore used. A fabric of this type, which is woven from fiber strands running in multiple directions, has the significant disadvantage, however, that it has many areas between the individual crossing fiber strands due to the weaving procedure, so-called crimp points, whose filling with artificial resin cannot be ensured. However, if an intermediate space without resin is situated within the composite material, the moisture in the cavity will condense and freeze during the large temperature variations to be expected in operation of a modern commercial aircraft. Each of these condensation and/or freezing actions is connected to a volume and pressure change. This effect, which repeats during every ascent and decent, results in rapidly increased material fatigue. This effect occurs even more strongly in larger cavities in the composite material. Multiaxial fabric of this type additionally has a very poor fiber/resin ratio.

In order to counteract this circumstance, the fuselage segments produced in this manner from a fiber material of this type are currently cured in a so-called autoclave, the composite material construction being placed under vacuum in order to remove the cavities therein. This method is very costly, and is only usable for components which fit in an autoclave with respect to their dimensions. The dimensions of the autoclave therefore set constructive limits on the maximum size of a fuselage segment. Currently, for example, the diameters of aircraft fuselages which may be produced from fiber composite materials are limited by the dimensions of the largest available autoclave. Moreover, the costs for the method are significantly increased by this method step, which is absolutely required in this known method for safety reasons. Thus, for example, to produce fuselage segments of large commercial aircraft of a producer, it is currently typical to produce a fuselage segment on one continent, and then to bring it to an autoclave on another continent using a wide-body freight aircraft over many thousands of kilometers. This method is not only costly, but rather is hardly acceptable in times of global climate change and the increasing scarcity of fossil fuels, because waste of valuable raw materials and contamination of the environment occur, which are irresponsible for future generations.

Even if all cavities are removed in the fiber composite material, the aircraft fuselage produced as described above still has significant further disadvantages. Due to the high number of free spaces in a multidirectional fabric, which must all absolutely be filled with artificial resin, however, a fabric of this type has a very poor ratio between fibers and resin. Parts made of a fiber composite material of this type are therefore relatively heavy in relation to their mechanical carrying capacity.

Due to the manufacturing of an aircraft fuselage in the form of individual fuselage segments, it is necessary to assemble the individual segments to form the overall fuselage. To assemble the individual segments, metal reinforcement elements, so-called fasteners, are attached to the fiber composite material. This has an array of disadvantages. To attach the reinforcement elements, it is often necessary to cut through the fibers of the fiber composite material at individual points, for example, by drilling or cutting. These cut-through fibers can no longer transmit forces, however, and are therefore useless for the strength of the affected component. In addition, the fiber composite material and the metal of the reinforcement elements have significantly different coefficients of thermal expansion. Because—as already described—an aircraft fuselage is subjected to significant temperature variations, the thermal strains thus occurring result in further material fatigue. In addition, a connection point of two components already represents a weak point per se.

A further disadvantage of the use of metal reinforcement elements is that if carbon fibers are used, components made of titanium cannot be used. This material, which is preferred per se with respect to density and carrying capacity, results in the occurrence of contact voltages in the composite with carbon fibers, the materials being decomposed at the contact point due to the continuous current flow. Therefore, components made of steel or aluminum must be used, whereby the total weight is increased further.

It would therefore be desirable and advantageous to provide an improved method of making a hollow body to obviate prior art shortcomings and to be able to form a large-volume cavity in a simple, rapid, and cost-effective manner, while having low weight and high mechanical carrying capacity in relation to its size.

### SUMMARY OF THE INVENTION

According to one aspect of the present invention, a method for producing a hollow body in sandwich construction includes the steps of forming an inner layer from of a specifiable number of plies of a fiber material which is at least resin-wetted, and arranging at least a first ply of the inner layer in the shape of a helix and without interruption essentially over an entire length of the hollow body.

Even a large-volume cavity can thus be formed simply, rapidly, and cost-effectively, which has a low weight and a high mechanical carrying capacity in relation to its size. Through the method according to the invention, a hollow body, in particular an aircraft fuselage or a tank, for example, for liquids or gases, can be formed, which can be manufactured in one piece, manufacturing of this type in one piece also being readily possible in the case of large units, such as the fuselage of a wide-body aircraft. Through the production in a single piece or component, additional, in particular metal connectors can be dispensed with. By dispensing with additional connectors and the assembly of multiple segments, it is not necessary to cut through the fiber strands of the fiber material, whereby the full advantages of fiber composite materials may be exploited. Not only is weight thus saved, but the hollow body produced according to the invention also has fewer weak points and thus a better carrying capacity as well as a longer service life.

Furthermore, the use of multiaxial fabric can be eliminated by the helical winding of the plies of the inner layer, because the individual plies may each be wound at different angles in different work steps during the construction of the inner layer, the possibility exists through the construction of this type of forming an inner layer which has fiber strands which run in all required specifiable directions. A hollow body, produced by a method according to the invention can thus be constructed from essentially unidirectional fabric. The use of a fabric of this type, in which essentially all fiber strands are situated parallel to the longitudinal extension of a web of the fabric, has the advantages that a fabric of this type is significantly more cost-effective than a multidirectional fabric, and additionally has significantly fewer areas between the individual fiber strands which are difficult to access. A unidirectional fabric hardly has any crossing points of fiber strands. Because most of the fiber strands are situated parallel, they may be penetrated simply by resin. In addition, unidirectional fabric can be laminated very successfully using rollers and presses. Through complete wetting, the disadvantages at crimp points may be reduced, because the handling of unidirectional fabric is simpler. A correspondingly formed hollow body will therefore have significantly fewer or no cavities within the fiber composite material. In addition, it is provided as per the method according to the invention that the inner layer is implemented accordingly. Therefore, even if a small number of cavities do occur in the fiber composite material, they are not subjected to the same temperature changes as in typical constructions, in which the outer skin of an aircraft is constructed in this manner. Therefore, from the plethora of the described reasons, a treatment in an autoclave can be dispensed with in the case of a hollow body produced as per the method according to the invention. In addition, a hollow body formed in this manner has a significantly better resin/fiber ratio than a comparable hollow body formed from multidirectional fabric, and therefore a significantly lower weight at equal volume and better strength, and less susceptibility to temperature change, as well as less material fatigue. The costly and environmentally-harmful air freight transport of individual segments can also be dispensed with by dispensing with the treatment in an autoclave.

Furthermore, using the inner layer as a load-bearing inner layer has the benefit that the outer layer may be kept very thin-walled, because it is only required for shaping, and/or for protecting an insulating layer. This has the advantage that damage of the outer layer does not cause weakening of the load-bearing structure and can be repaired very simply.

Aircraft fuselages produced by a method according to the invention have a significantly better carbon dioxide balance than typically produced aircraft fuselages. In addition, they are lighter, because of which an aircraft having a fuselage of this type requires less fuel, and, in addition to lower production and therefore also acquisition costs, also has lower operating costs, connected to a higher operational reliability.

According to another aspect of the present invention, a hollow body constructed essentially in sandwich construction, comprising an inner layer facing toward an interior of the hollow body and including at least one first ply of fiber composite material, wherein the at least the first ply has a helical configuration and extends without interruption essentially over an entire length of the hollow body.

According to still another aspect of the present invention, a device for producing a fiber material which is at least wetted with resin, includes a storage unit for a web of non-wetted fiber material, at least one vessel for receiving a specifiable quantity of resin, and an assembly to guide at least a first area of the web from the storage unit in the resin of the vessel to implement a repeated immersion of the web in the resin.

With a device according to the present invention, the shortcomings encountered in the prior art involving wetting of essentially all fibers of the fiber material, causing areas in the fiber material in the absence of resin and thus representing weak points of a fiber composite material, is eliminated. Good wetting or penetration of a fiber material with resin can thus now achieved in a continuous method with a device according to the invention. Through the repeated submersion, combined with the intermediate phases in which the fiber material is situated outside the resin, the resin can have enough time to penetrate into the intermediate spaces of the fiber material.

### BRIEF DESCRIPTION OF THE DRAWING

Other features and advantages of the present invention will be more readily apparent upon reading the following description of currently preferred exemplified embodiments of the invention with reference to the accompanying drawing, in which:

FIG. 1 shows a first step of a method according to the invention in a first axonometric view;

FIG. 2 shows a first part of a preferred configuration for performing the method according to the invention in an axonometric view;

FIG. 3 shows a second part of a preferred configuration for performing the method according to the invention in outline;

FIG. 4 shows the part according to FIG. 3 in an axonometric view;

FIG. 5 shows a view of a hollow body according to the invention having three parts according to FIG. 3 in an axonometric view;

FIG. 6 shows a device for producing a fiber material which is at least partially wetted with resin in an axonometric view;

FIG. 7 shows the first step of the method according to the invention in a second axonometric view;

FIG. 8 shows a second step of a method according to the invention in a first axonometric view;

FIG. 9 shows a third step of a method according to the invention in an axonometric view;

FIG. 10 shows a cavity according to the invention after the third step of a method according to the invention in lateral outline;

FIG. 11 shows section A-A from FIG. 10 in outline;

FIG. 12 shows detail A from FIG. 11 in outline;

FIG. 13 shows detail B according to FIG. 11 in outline and lateral outline;

FIG. 14 shows a cavity according to the invention during the fourth step of the method according to the invention in an axonometric view;

FIG. 15 shows a cavity according to the invention after the fourth step of a method according to the invention in lateral outline;

FIG. 16 shows section B-B from FIG. 15 in an axonometric view;

FIG. 17 shows detail C from FIG. 16 in outline;

FIG. 18 shows section C-C from FIG. 17 in lateral outline, having two connected outer layer elements;

FIG. 19 shows the outer layer elements from FIG. 18 before their assembly;

FIG. 20 shows detail D from FIG. 16 in outline, having two connected outer layer elements;

FIG. 21 shows the outer layer elements from FIG. 20 before their assembly;

FIG. 22 shows a sectional illustration of a hollow body according to the invention after the foaming;

FIG. 23 shows detail E from FIG. 22 in outline;

FIG. 24 shows section E-E from FIG. 23 in lateral outline;

FIG. 25 shows detail F from FIG. 22 in outline;

FIG. 26 shows a profile bracing in an axonometric view;

FIG. 27 shows a cavity according to the invention after the installation of specifiable built-ins in the interior in an axonometric view;

FIG. 28 shows a cavity according to the invention in an axonometric view, ready for curing; and

FIG. 29 shows a cavity according to the invention in an axonometric view after the door and window openings are cut out.

### DETAILED DESCRIPTION OF PREFERRED EMBODIMENTS

Throughout all the figures, same or corresponding elements may generally be indicated by same reference numerals. These depicted embodiments are to be understood as illustrative of the invention and not as limiting in any way. It should also be understood that the figures are not necessarily to scale and that the embodiments are sometimes illustrated by graphic symbols, phantom lines, diagrammatic representations and fragmentary views. In certain instances, details which are not necessary for an understanding of the present invention or which render other details difficult to perceive may have been omitted.

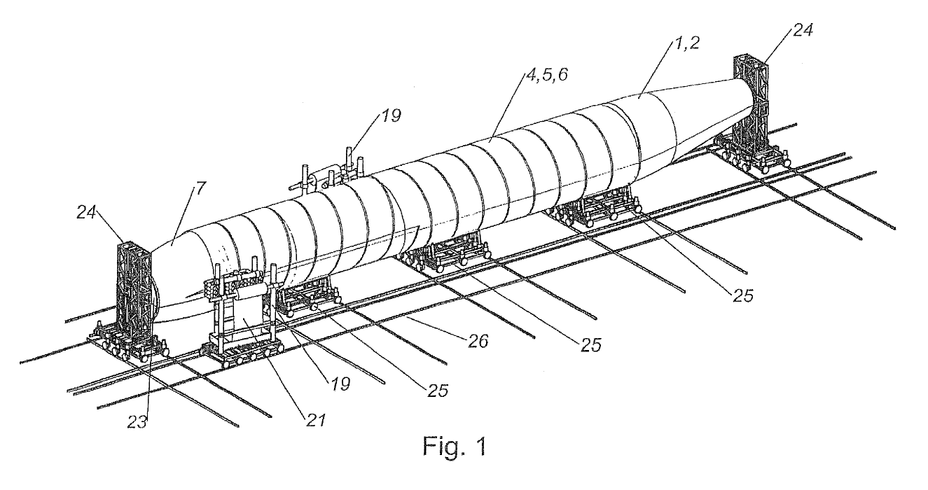

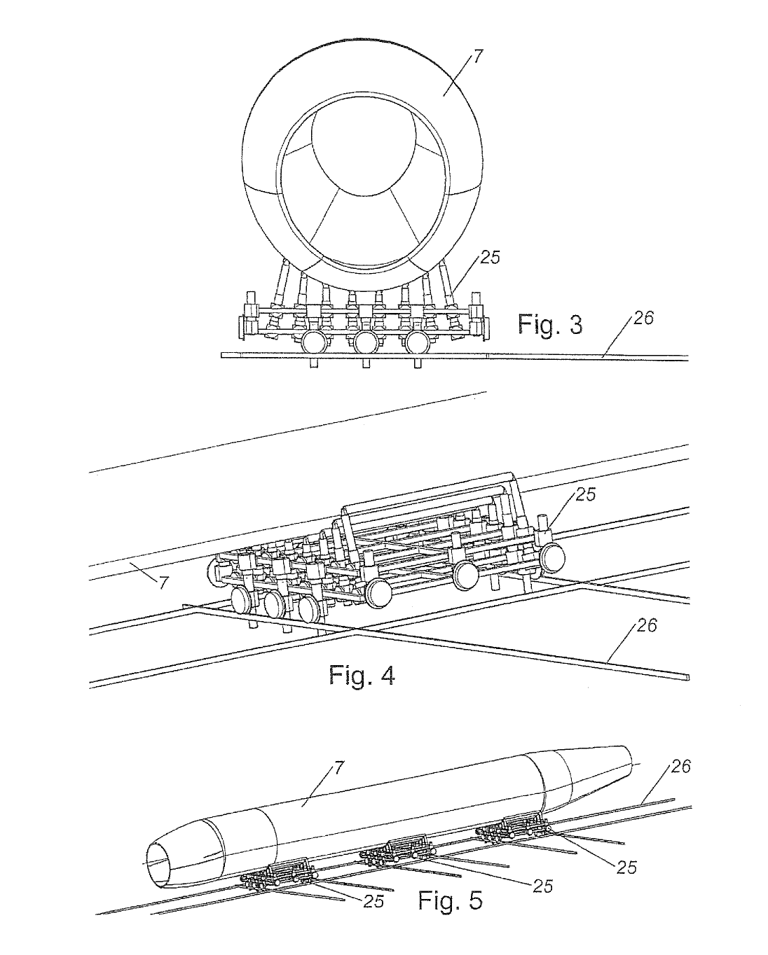

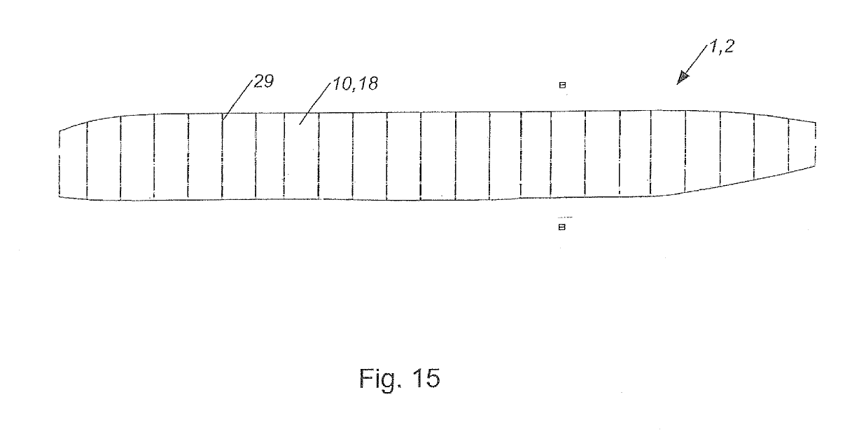

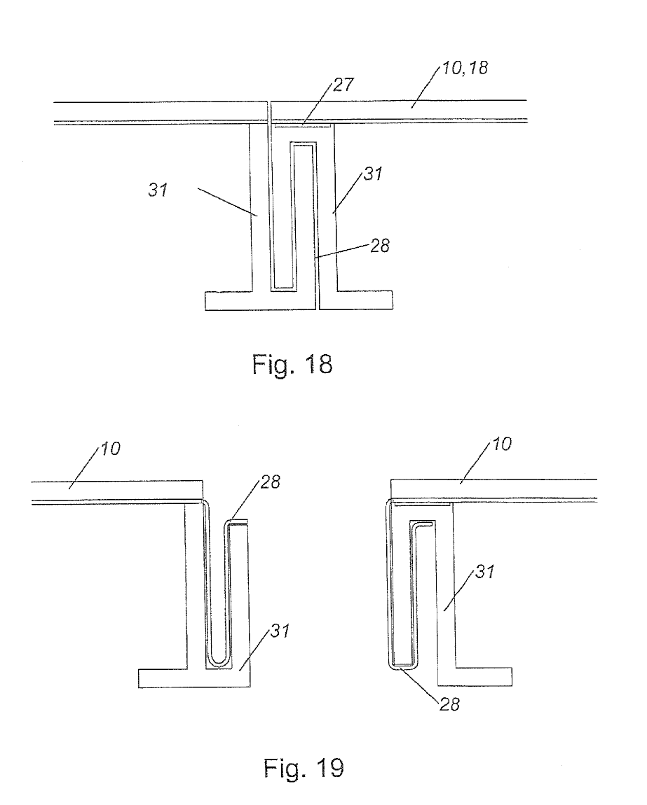

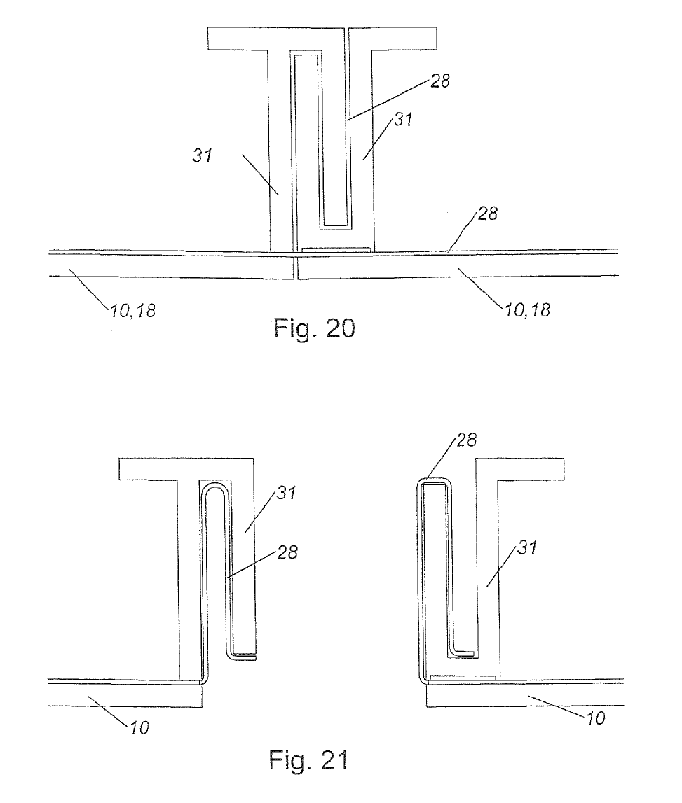

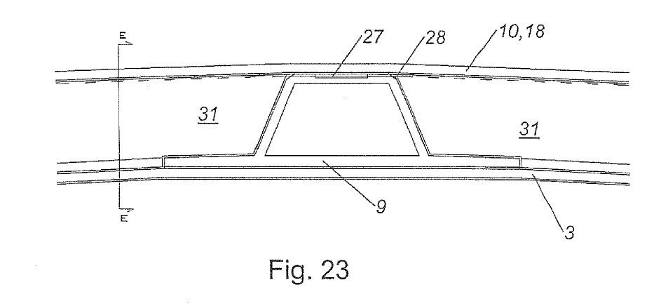

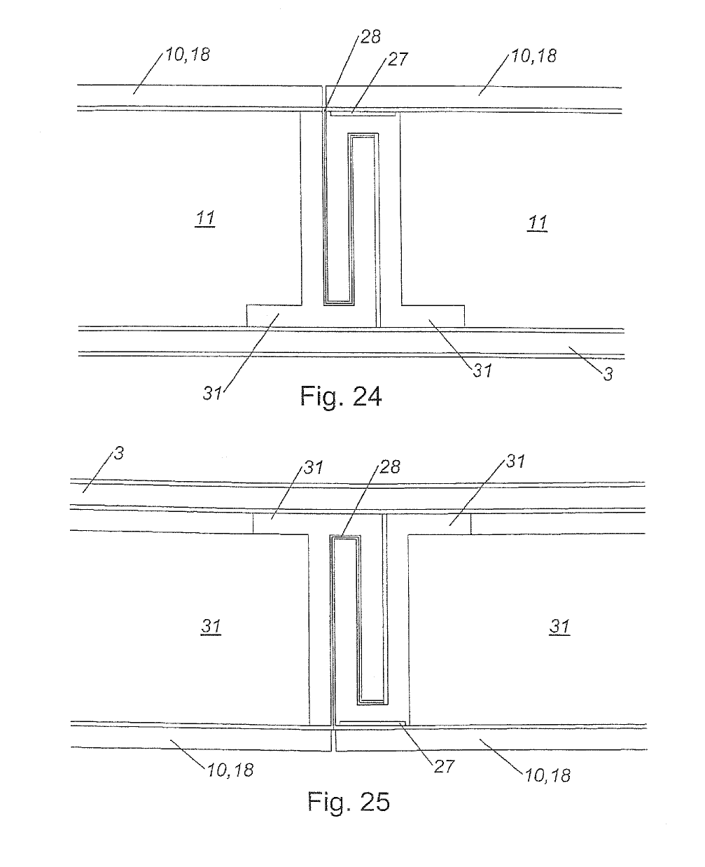

FIGS. 1 through 29 show individual steps of a preferred method for producing a hollow body 1—implemented as a sandwich construction—which is shown in the figures, in its preferred embodiment as an aircraft fuselage 2, an inner layer 3 being formed from a specifiable number of plies 4 of a specifiable fiber material 5, which is at least resin-wetted, and comprises carbon fibers in particular, at least one first ply 6 of the inner layer 3 being situated in a helix and without interruption—essentially over the entire length of the hollow body 1.

Furthermore, these figures show a hollow body 1, or details of a hollow body and partially finished hollow bodies in the preferred form of an aircraft fuselage 2, which is essentially implemented as a sandwich construction, comprising an inner layer 3—facing toward an interior 15 of the hollow body 1—which at least comprises a first ply 6 of a specifiable fiber composite material 5, in particular comprising carbon fibers, at least the first ply 6 of the fiber composite material 5 being situated in a helix and without interruption—essentially over the entire length of the hollow body 1, and the inner layer 3 preferably being implemented as essentially the sole load-bearing layer of the sandwich construction—at least peripherally.

Even a large-volume cavity 1 can thus be formed simply, rapidly, and cost-effectively, which has a low weight and a high mechanical carrying capacity in relation to its size. Through the method according to the invention, a hollow body 1, in particular an aircraft fuselage 2 or a tank, for example, for liquids or gases, can be formed, which can be manufactured in one piece, manufacturing of this type in one piece being readily possible even in the case of large units, such as the fuselage of a wide body aircraft. Through the production in a single piece or component, additional, in particular metal connectors can be dispensed with. By dispensing with additional connectors and the assembly of multiple segments, it is not necessary to cut through the fiber strands of the fiber material, whereby the full advantages of fiber composite materials may be exploited. Not only is weight thus saved, the hollow body 1 produced according to the invention also has fewer weak points and thus a better carrying capacity and a longer service life.

Furthermore, the use of multiaxial fabric can be dispensed with by the helical winding of the plies 4 of the inner layer 3, because the individual plies 4 can each be wound at different angles in different work steps during the construction of the inner layer 3, the possibility exists of forming an inner layer 3 through the construction of this type which has fiber strands which run in all required specifiable directions. Therefore, a hollow body 1 as per the method according to the invention can be constructed from essentially unidirectional fabric. The use of a fabric of this type, in which essentially all fiber strands are situated parallel to the longitudinal extension of a web 21 of the fabric, has the advantages that a fabric of this type is significantly more cost-effective than a multidimensional fabric, and additionally has significantly fewer areas between the individual fiber strands, which are poorly accessible for the resin. A unidirectional fabric hardly has any crossing points of fiber strands. Because most fiber strands are situated parallel, they may be penetrated easily by resin. In addition, unidirectional fabric can be laminated very successfully using rollers and presses. The disadvantages in the case of crimp points may be reduced by complete wetting, because the handling of unidirectional fabric is simpler. A correspondingly formed hollow body 1 will therefore have significantly fewer or no cavities within the fiber composite material. In addition, it is provided as per the method according to the invention that the inner layer 3 is implemented accordingly. Therefore, even if a small number of cavities do occur in the fiber composite material, they are not subjected to the same temperature changes as in typical constructions, in which parts of the outer skin of an aircraft are constructed in this manner. From the plethora of the listed reasons, a treatment in an autoclave can therefore be dispensed with in the case of a hollow body 1 produced as per the method according to the invention. In addition, a hollow body 1 formed in this manner has a significantly better resin/fiber ratio than a comparable hollow body formed from multidimensional fabric, and therefore a significantly lower weight at the same volume and better strength, and lower susceptibility to temperature changes, as well as less material fatigue. The cost-effective and environmentally-harmful air freight transport of individual segments can also be dispensed with by dispensing with the treatment in an autoclave.

Furthermore, the outer layer 18 can be kept very thin-walled by the preferred implementation of the inner layer 1 as a load-bearing inner layer, because it is only required for shaping and/or for protecting an insulating layer. This has the advantage that damage of the outer layer 18 does not represent weakening of the load-bearing structure and is very simple to repair.

Aircraft fuselages 2 produced as per the method according to the invention have a significantly better carbon dioxide balance than typically produced aircraft fuselages. In addition, they are lighter, because of which an aircraft having a fuselage of this type requires less fuel, and, in addition to lower production and therefore also acquisition costs, also has lower operating costs, combined with higher operational reliability.

A cavity 1 in the meaning of the present invention can be any type of a cavity 1. In particular, it is provided that a cavity 1 according to the invention forms a pressurized body or a part, preferably a substantial part, of a pressurized body, such as its entire side wall, for example, in the case of an essentially cylindrical pressurized body. According to particularly preferred embodiments, it is provided that a hollow body 1 according to the invention or a hollow body 1 formed as per the method according to the invention is implemented as a pressurized tank, aircraft fuselage 2, or submarine pressurized body. The essential advantages of the particularly preferred implementation of the hollow body 1 as an aircraft fuselage 2, which is described in greater detail hereafter, were already explained above. The advantages upon implementation of the hollow body 1 as a pressurized tank result therefrom. Upon implementation of the hollow body 1 as a submarine pressurized body—in particular in the case of military applications—the good noise damping and the lack of metal parts in the construction result in further advantages, whereby a submarine pressurized body of this type does not cause magnetic anomalies of the Earth's magnetic field, and is less easily detectable.

A particularly preferred implementation of a method according to the present invention for producing a hollow body 1 is described hereafter in detail on the preferred example of the production of an aircraft 2.

A hollow body 1 according to the invention is implemented as a sandwich construction, therefore has a multilayered component, which has at least one inner layer 3 and at least one outer layer 18, an intermediate layer being situated between the two layers 3, 18. The inner layer 3 and the outer layer 18 are implemented comprising fiber material. The intermediate layer is preferably implemented comprising plastic foam.

Any fiber material comprising naturally or artificially produced fibers can be provided as the fiber material, preferably comprising glass fibers, aramid fibers, carbon fibers, and/or polyester fibers, mixtures of one or more of the above-mentioned fibers being able to be provided in particular in a fiber material and/or the inner or outer layer 3, 18. It is preferably provided that the fiber material is processed in the form of a unidirectional fabric. In a fabric of this type, which is available in the form of webs currently having at most approximately 2.4 m width, most fibers are situated parallel to one another in the longitudinal direction of the web. Only a very small number of further fibers is used so that the individual fibers running in the longitudinal direction maintain their place in the fabric and are not displaced.

It is provided that the fiber material is at least wetted with a resin, in particular an artificial resin, such as polyester resin and/or epoxy resin, for its processing. The expression at least “wetted” preferably refers to the state in which precisely the minimal quantity of resin required for processing the fiber material is bonded to the fiber material or is located thereon.

It is provided according to the invention that the first ply 6 of the inner layer 3 is situated in a helix and without interruption—essentially over the entire length of the hollow body 1, it being particularly preferable for the inner layer 3 to be implemented as essentially the sole load-bearing layer of the sandwich construction—at least peripherally. Therefore, the inner layer 3 has a sufficient number of plies 4 of the fiber material 5 so that the inner layer 3 per se is already capable of absorbing the pressures to be expected in operation. In the case of a commercial aircraft, this pressure differential, which must be able to be absorbed by the inner layer 3, results from the difference of the internal cabin pressure at cruising altitude, typically the equivalent pressure to an altitude between 1400 and 2400 m above sea level, and the ambient pressure at the planned cruising altitude. In addition, there are further safeguards prescribed by standards and regulations, such as the FAA regulations. Therefore, a varying number of plies 4 of the inner layer 3 are to be provided depending on the planned intended use. In addition, the further strain by the acceleration and weight forces are added. For this purpose, however, it is provided that further structural elements are added—as explained in greater detail hereafter.

As per the method according to the invention, it is provided that essentially the entire hollow body 1, therefore the aircraft fuselage 2 in the present case, is to be produced in one piece according to the invention. As is obvious in the figures, the entire aircraft fuselage 2 is produced without interruption in one piece up to the outermost ends of the aircraft fuselage 2, therefore the end of the tail of the aircraft fuselage 2, and the cockpit area or the radome.

The formation of an aircraft fuselage 2 is described hereafter, the particular required method steps being able to be applied to the production of any other hollow body 1 according to the invention without restriction.

To form the inner layer 3, it is provided that the first ply 6 of the inner layer 3 is applied to a form 7, which is preferably at least regionally convex at least peripherally, by preferably continuous rotation of the form 7 around a rotational axis 8 and forward movement of the at least resin-wetted fiber material 5 essentially parallel to a rotational axis 8 of the form 7. Preferably, any cross-section which can be composed of convex and/or straight lines can be provided. FIG. 1 shows a corresponding configuration to form an aircraft fuselage 2, a form being suspended so it is rotatable at its ends.

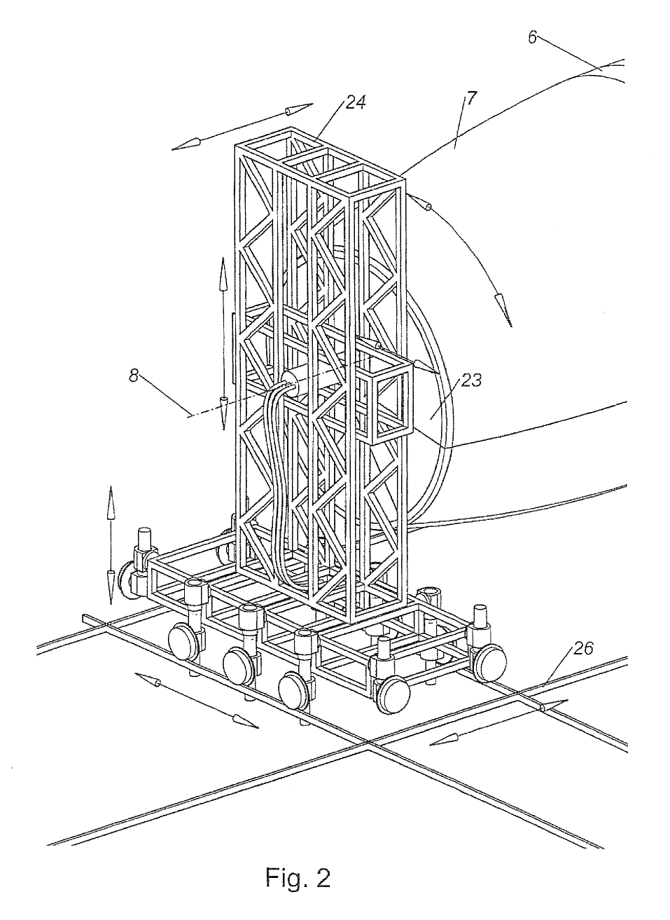

The form 7 can be implemented as any type of a form 7, which allows the removal thereof from the interior of an essentially finished aircraft fuselage 2. It is preferably provided that the form 7 is implemented as a hollow body which is inflatable or inflated in operation. It is preferably provided that a high pressure is applied to the form in order to prevent sagging thereof as much as possible. In order to further reduce sagging of the form, it can be provided that it is filled with a lighter-than-air gas, such as helium. The form 7 is particularly preferably implemented comprising a silicone-impregnated glass fiber fabric on its outer side. Through the silicone impregnation, good detachment from the surface of the inner layer 3 is to be expected and, in addition, a smooth inner surface of the aircraft fuselage 2 is thus already generated—upon corresponding surface quality of the form 7. This surface can thus be used as the inner surface of the aircraft fuselage 2 without further postprocessing, for example. Furthermore, through the glass fiber fabric it is possible to deaerate the form 7 for its removal from the aircraft fuselage 2, and to slightly collapse it and/or pull it off of the inner layer. The form 7 has a flange 23 on each of its ends, which, as shown in FIG. 2, is rotatably fastened on a—preferably adjustable—carrier device 24. Through the use of a glass fiber fabric, a very light but nonetheless stable and, above all, torsionally-rigid form 7 may be provided. It is expected that the mass of a form 7 of this type having a length of 60 m will be between 400 kg and 600 kg.

Because regional sagging of the form 7 cannot be prevented in spite of the glass fiber fabric and the inflation of the form 7, in particular in the case of longer aircraft fuselages 2, of course, as in the case of any long object, a specifiable number of roller support bearings 25 are provided as shown in FIGS. 1, 3, 4, and 5. The carrier devices 24 and the roller support bearings 25 are preferably movably mounted on rails 26 for their positioning.

A further effect can be achieved by the roller support bearings 25. They have an array of contact pressure rollers facing toward the form 7, whereby additional pressure can be applied to the form 7 and/or a previously applied ply 4 during the lamination procedure of the fiber material 5. Through this additional compression action, the density of the applied ply can be increased further. In addition, it is preferably provided that the roller support bearings 25 are moved along the longitudinal axis during the lamination procedure, so that essentially all areas of the hollow body can be additionally pressed by the roller support bearings 25. It is preferably provided that at a length of the hollow body of approximately 60 m, three roller support bearings 25 are provided, which are each 4 m long.

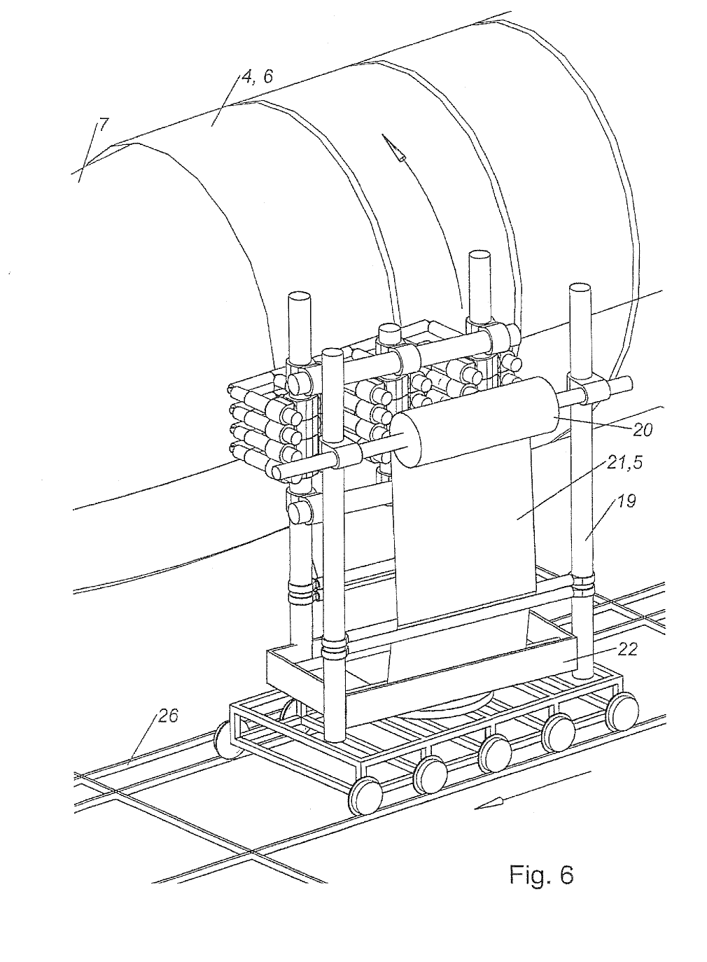

A device 19, as shown in detail in FIG. 6, for example, is preferably provided for applying the fiber material 5 to the form 7 and/or, in the case of further plies 4, to the particular lower ply 4 of a previously processed fiber material 5. A device 19 of this type for producing a fiber material 5 which is at least partially wetted with resin has at least one storage configuration 20 for a web 21 of a non-wetted fiber material 25, as well as at least one vessel 22 for receiving a specifiable quantity of resin. Furthermore, this device 19 is preferably also mounted as drivable to move on rails 26, whereby a specifiable feed of the fiber material 5 can be achieved. In order to achieve the best possible wetting of the fiber material 5 with resin, it is provided that the device 19 is implemented for the repeated immersion of at least a first area of the web 21 of the fiber material 5 in the resin. The device 19 has a specifiable number of deflection rollers for this purpose, every second deflection roller being situated in the vessel in such a manner that this deflection roller is immersed in the resin in the case of a correspondingly resin-filled vessel, and the further deflection rollers situated between these deflection rollers being situated outside the resin. Good wetting or penetration of a fiber material 5 with resin can thus be achieved in a continuous method. The vessel 21 further preferably has a heating device, in order to make the resin free-flowing by heating, whereby it can also penetrate more easily into the fiber material. Through the repeated immersion, connected with the intermediate phases in which the fiber material 5 is situated outside the resin, the resin can have sufficient time in order to penetrate into the intermediate spaces of the fiber material 5.

Furthermore, the device 19 for producing a fiber material 5, which is at least partially wetted with resin, has a pressure roller configuration, in order to remove excess resin from the fiber material 5, before it is applied to the form 7 or a ply 4 of the inner layer 3. Furthermore, contact pressure rollers may be provided in order to press the at least wetted fiber material 5 against the form 7 or a ply 4 of the inner layer 3. Furthermore, rolls are particularly preferably provided, which each have at least one screw channel, a paired right hand/left hand configuration of screws of this type preferably being provided, which also press the fiber material 5 against the form 7. Through rolls of this type having screw channels, a ply 4 can be deaerated particularly well, air inclusions possibly still present in the ply therefore being removed therefrom. Through the device 19 according to the invention, a specifiable fiber/resin ratio can be achieved in the plies 4 simply and reliably. It is preferably provided that the fiber/resin ratio is approximately 70/30.

The device 19 for producing a fiber material 5 which is at least partially wetted with resin is implemented for the helical application of a web 21 of a fiber material 5 to the form 7. It is preferably provided that the first innermost ply 6 of the resin-impregnated fiber material 5 is wound on the form 7 with continuous rotation of the form 7 essentially in a helix, preferably at an angle between 80° and 45° to the rotational axis 8 of the form 7, and the device 19 is implemented accordingly for this purpose. For the flexible specification of the angle it is provided that at least parts of this device 19 are angularly adjustable. In addition, it is preferably provided that the entire device 19 is implemented to follow a contour of the form 7. It can also be provided that parts of this device 19 are implemented by an industrial robot, in particular having serial kinematics.

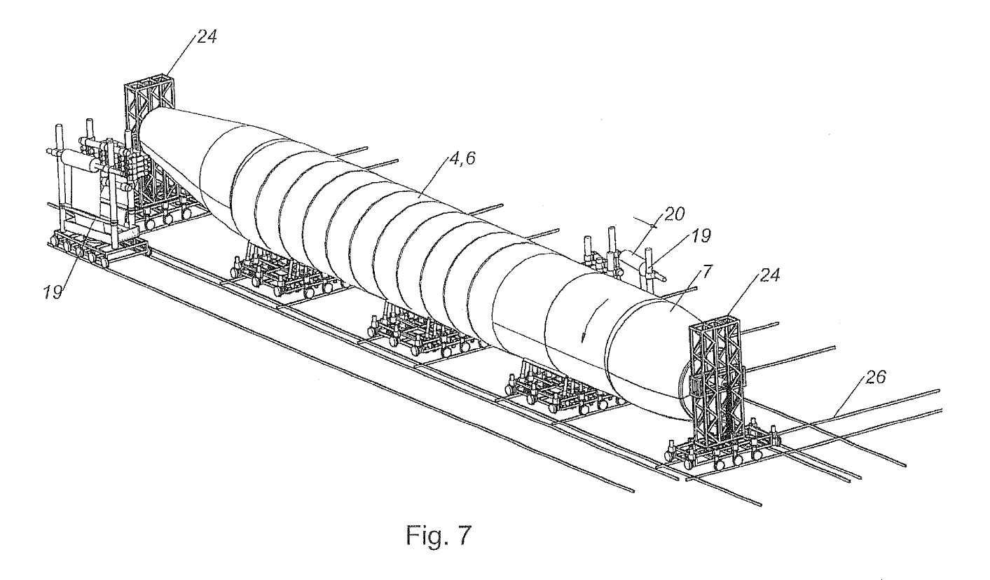

To apply the first ply 6 of the inner layer 5, it is therefore provided that the form 7 is set into rotation via its flange 23 and the carrier device 24. It is provided that a constant speed of the form 7 is maintained, and no vibrations occur between the two carrier devices 24, which drive the form 7, for example, due to an unstable control loop. The at least resin-wetted fiber material 5 for forming the first ply 6 of the inner layer 3 is applied directly to the form 7—preferably without further separating agent—beginning at one end, at the rear according to FIG. 1, for example, and the fiber material 5 being wound in a helix on the form 7 without interruption by continuous steady feed of the device 19, an angle of essentially 45° to the rotational axis 8 of the form 7 particularly preferably being provided. It is provided that the fiber material 5 is wound in a helix in such a manner that overlaps of the turns of the fiber material 5 of the same web occur, the amount of the overlap resulting from the angle to the rotational axis 8, the dimensions of the form 7, and the width of the web 21. FIGS. 1 and 7 show the application of the first ply 6 of the inner layer 3 formed in this manner to the form 7 in different views in each case.

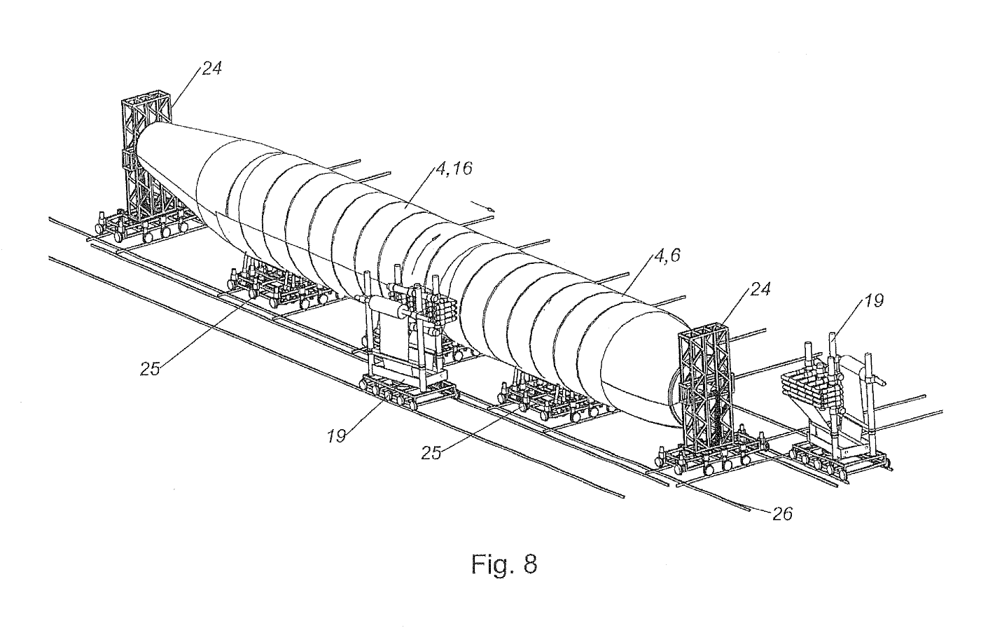

After application of the first ply 6, it is provided that the second ply 16 is applied. It is preferably provided that the second ply 16 is applied crossing the first ply 6, therefore, the individual fiber strands of the fiber material 5 of the second ply 16 cross the corresponding fiber strands of the first ply 6 at a specifiable angle. FIG. 8 shows a preferred configuration for applying a crossing second layer 16, a further device 19 being provided. The second ply 16 can thus be wound crossing the first ply 6, without stopping of the rotation of the form 7 and a rotation in the corresponding opposing direction being required for this purpose. Valuable processing time can be saved by a further device 19 of this type.

All further plies 4 of the inner layer 3 are applied in the way described to the particular lower ply 4 thereafter, it preferably being provided that two plies closest to one another are situated crossing one another. Combining different fiber materials 5 can also be provided, in order to achieve special specifiable properties of the aircraft fuselage. Thus, for example, aramid fabric can be used in order to increase the ballistic resistance of the inner layer 3.

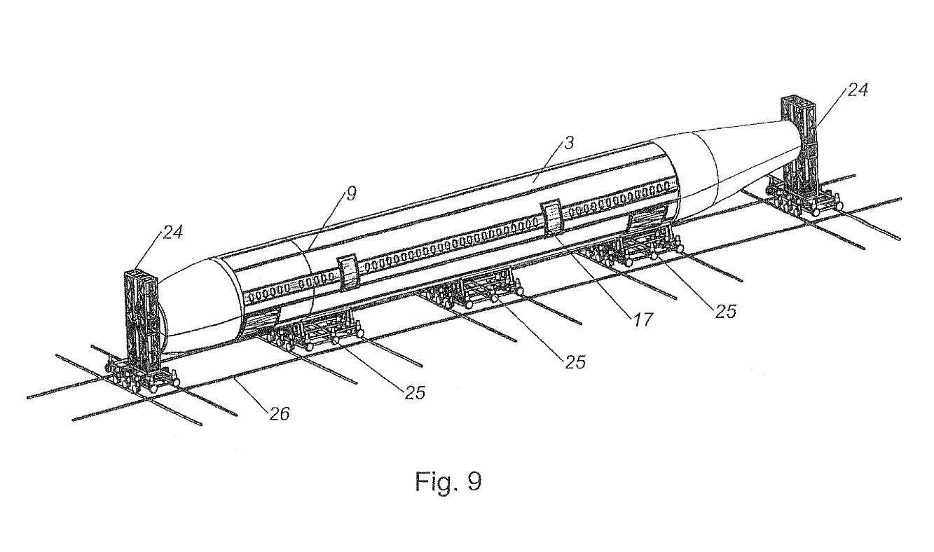

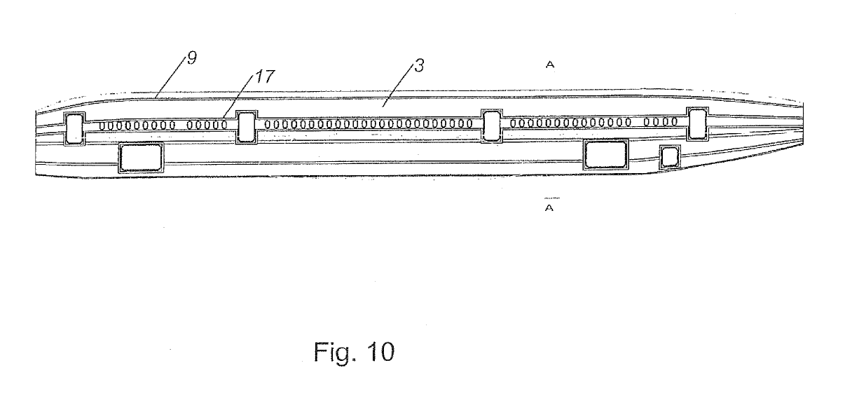

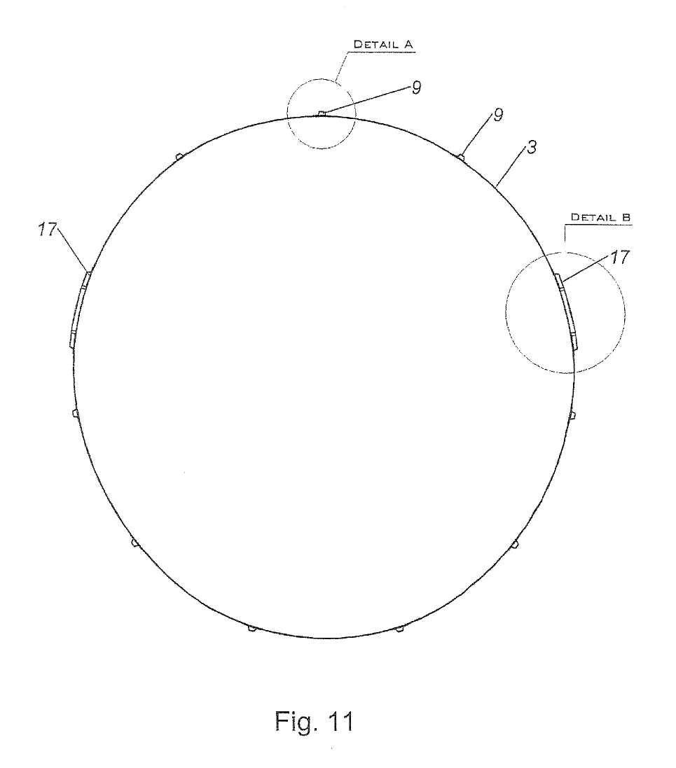

In a further method step, it is provided that—essentially immediately—after application of all plies 4, 6, 16 of the at least resin-wetted fiber material 5 of the inner layer 3, a specifiable number of profile elements 9, 17, preferably comprising fiber composite material, are applied along a longitudinal extension of the hollow body 1, to the inner layer 3, in particular using at least resin-wetted fiber material 5. Through profile elements 9, 17 of this type running in the longitudinal extension of the aircraft fuselage 2, the aircraft fuselage 2 is reinforced with respect to the absorption of the forces and torques to be expected in just this longitudinal extension. FIGS. 9 and 10 show an inner layer 3 of an aircraft fuselage 2, to which the corresponding profile elements 9, 17 have already been applied. FIG. 11 shows a cross-section along section A-A in FIG. 10. It may be seen that two types of profile elements 9, 17 have been applied to the inner layer 3. In addition to first profile elements 9, which are preferably implemented as essentially linear or following the contour of the inner layer 3, further so-called door and/or window profile elements 17 have been applied to the inner layer 3.

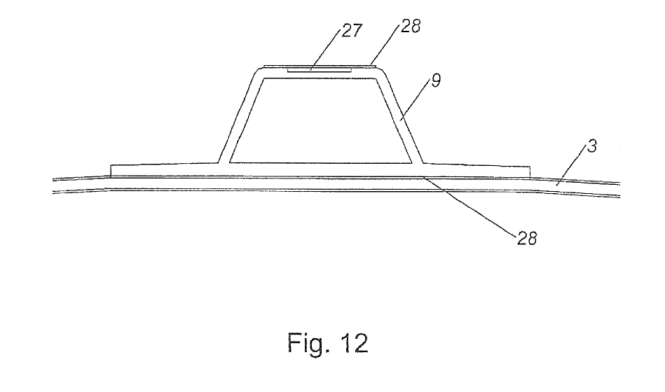

The profile elements 9, 17, both the first profile elements 9 and also the door and/or window profile elements 17, preferably have a boxy hollow cross-section, and are preferably also implemented comprising a fiber material. FIG. 12 shows a preferred cross-section of a first profile element 9. It preferably has a metal layer 27, such as a copper strip, for lightning conduction on an area facing toward the outer layer 18. The profile elements 9 are preferably connected to the inner layer 3 using fiber material in the form of so-called pre-preg fabric strips 28. Upon application of the profile elements 9, 17 to the inner layer 3, the inner layer 3 is not yet cured. The application of the profile elements 9, 17 is therefore performed essentially immediately after application of the last ply 4 on the inner layer 3. A further pre-preg fabric strip 28 is preferably situated above the metal layer 27, in order to produce a preferred connection to an outer layer 18.

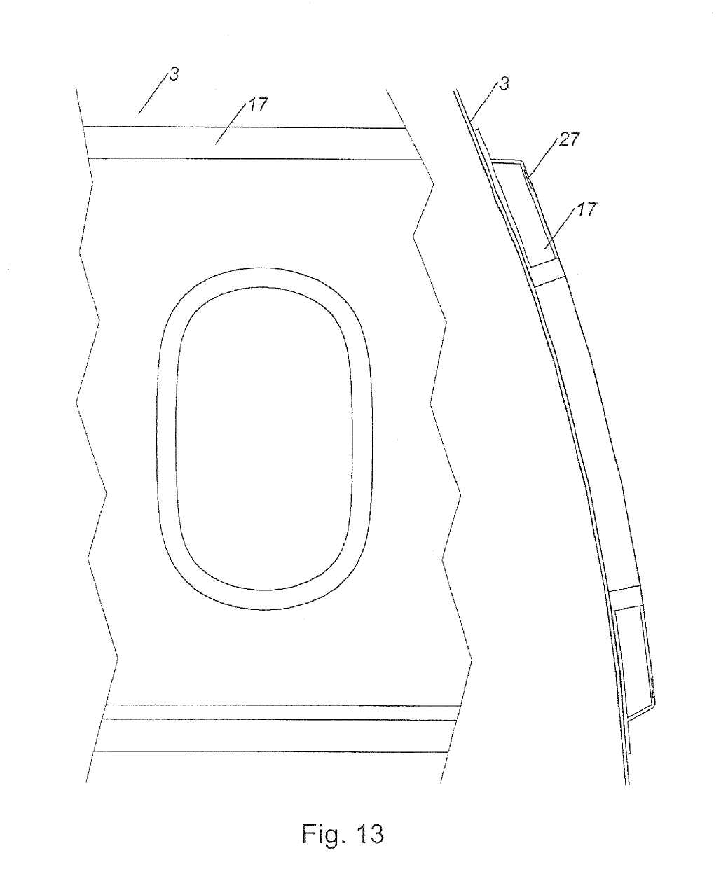

FIG. 13 shows a preferred embodiment of a door and/or window profile element 17. As shown, it also has a hollow cross-section, as well as the metal layer 27. The door and/or window profile elements 17, which are preferably also connected using pre-preg fabric strips 28 to the inner layer 3, only have the contours of the window openings 14, door opening 13, and further openings of the aircraft fuselage 2, such as landing gear shafts, cargo space doors, maintenance flaps, and access openings for external power supply or supply of compressed air. After this method step, the aircraft fuselage 2 does not yet have the corresponding openings itself, however. Their outlines are only specified by the door and/or window profile elements 17. It can be provided that a separate door and/or window profile element 17 is provided for each intended opening. However, a special door and/or window profile element 17 can also be provided, which borders a specifiable number of intended openings, whereby the application of the required number of door and/or window profile elements 17 can be significantly accelerated.

After the complete application of all profile elements 9, 17, it is provided in a next method step that a specifiable number of non-load-bearing outer layer segments 10 are situated peripherally, and preferably in the longitudinal extension. The outer layer 18, which is identical to the later outer skin of the aircraft fuselage 2, is therefore already produced beforehand in the form of individual outer layer segments 10 and is only applied to the aircraft fuselage 2 upon finishing thereof.

The outer layer segments 10 are provided for the purpose of not absorbing or transmitting any substantial forces, and preferably have a total thickness of approximately 0.3 to 1 mm, in particular approximately 0.5 mm, for example. The outer layer segments 10 may be produced flatly, whereby their production and transport can be performed very simply and economically. The outer layer segments 10 may be produced already completely finished. They are therefore preferably produced already completely lacquered and installed in such a state on the aircraft fuselage 2.

It is preferably provided that an outer layer segment 10 only has a single ply 4 of a fiber material 5 on its side facing toward the inner layer 3. This single ply 4 is covered by a further ply of a fine fiber nonwoven material, in order to achieve a very smooth surface. A preferably conductive paint or a conductive lacquer is applied to this layer of fiber nonwoven material, whereby a further increase of the lightning protection of the aircraft fuselage 2 can be achieved. It can be provided that a further layer of a metal material, such as a copper fabric, is situated between the lacquer and the fiber nonwoven material. A particular advantage of these very thin-walled outer layer segments 10 is that in case of damage, for example, by a bird strike, no load-bearing parts are affected, and thin-walled fiber materials can be repaired very simply, because it is not necessary to expose the single plies 4.

Before application of the outer layer segments 10 to the aircraft fuselage 2, they are heated above the glass temperature, whereby they may be bent easily, and bent to the desired contour.

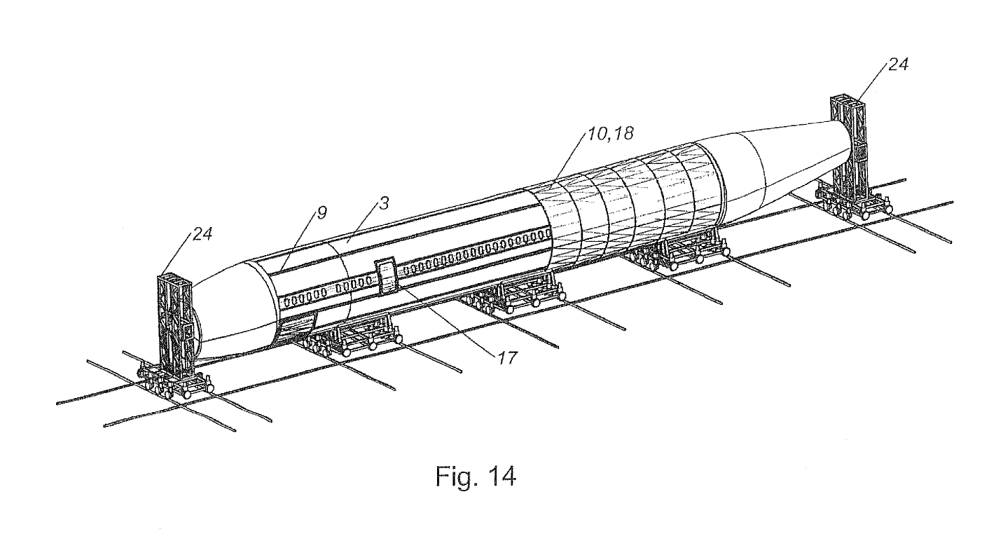

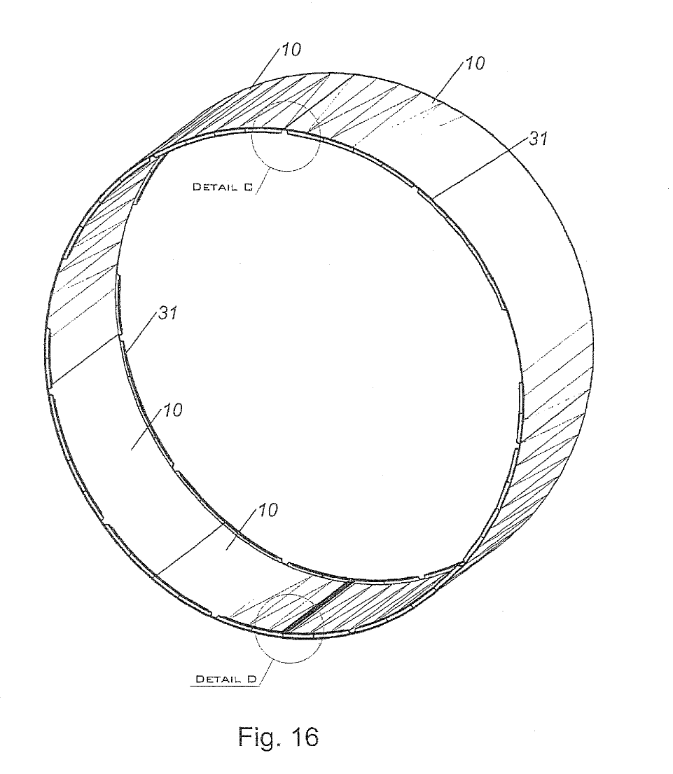

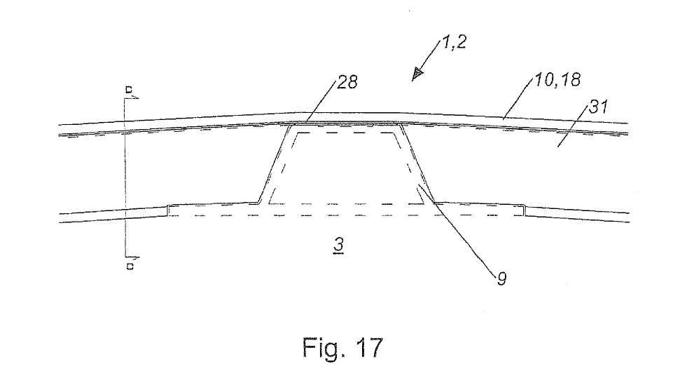

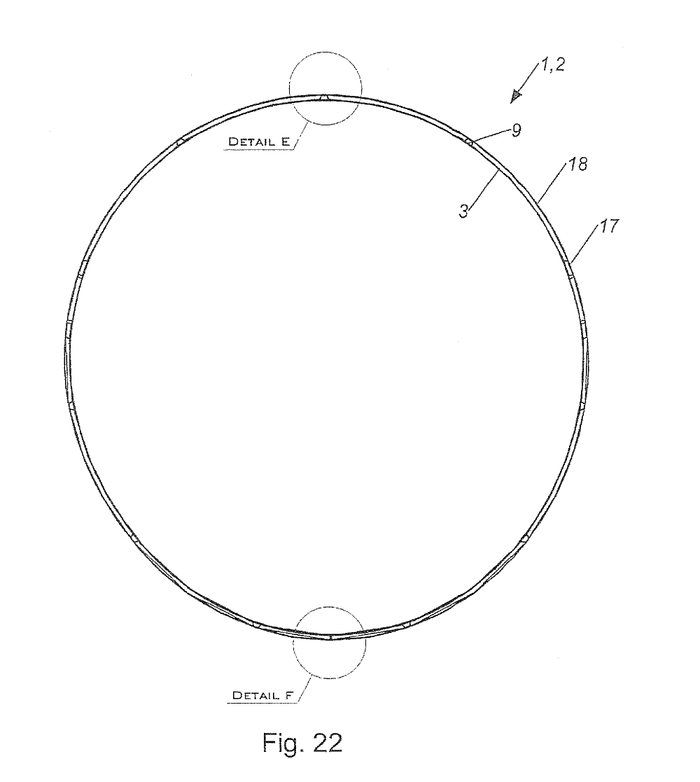

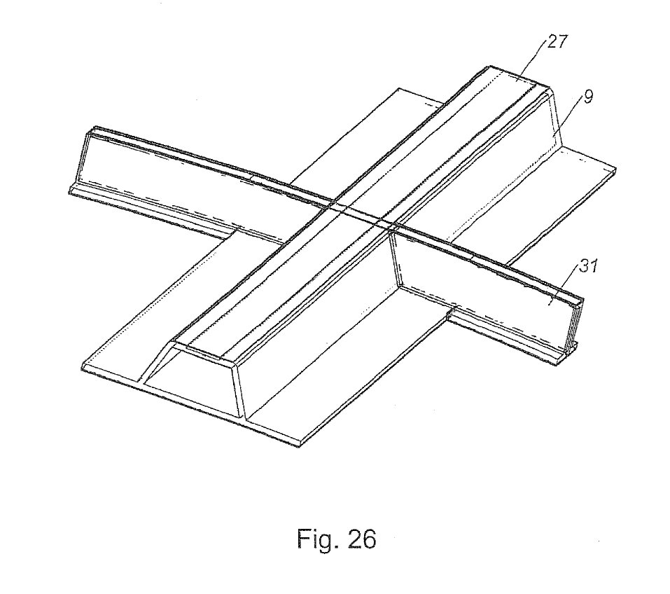

It is preferably provided that the single outer layer segments 10 are each positively connected to one another, and preferably rest on the profile elements 9. FIG. 14 shows a view of an aircraft fuselage 2, in which a part of the outer layer segments 10 has already been applied. For better illustration of the division of the outer layer segments 10 and their positive connection, FIG. 16 shows a circumference only formed from outer layer segments 10. As is recognizable in FIG. 17, the outer layer segment 10 rests on the first profile element 9, to which it is connected using the pre-preg fabric strip 28. FIGS. 18 through 21 each show details of two outer layer segments 10 before and after their connection. The connection areas 31 of the outer layer segments 10, which are provided for the purpose of being connected to one another, are preferably provided with a pre-preg fabric strip 28. As may be inferred from the further detail views according to FIGS. 22 through 25, a positive connection of adjoining outer layer segments 10 of this type is provided both peripherally and also in the longitudinal direction. During the peripheral application of the outer layer segments 10, it can be provided that the outer layer segments 10 are clamped together using a compression tool, such as a belt, so that the individual connection areas 31 of the outer layer segments 10 interlock. FIG. 26 shows a crossing point between a first profile element 9 and a connection area 31 of an outer layer segment 10.

Through the preferred design of the connection areas 31 of the outer layer segments 10, each in the form of a combined U-profile and L-profile, as shown in FIGS. 18 through 21, a double T-profile having a very stable vertical adapter is formed upon the connection of two adjoining outer layer segments 10. The connection areas 31 of the outer layer segments 10 therefore form peripherally closed double T-profiles, which provide the aircraft fuselage 2 with additional strength and stability like frames.

The connection areas 31 of the outer layer segments 10 form essentially terminated and delimited cavities 11 between the inner layer 3 and the outer layer 18 formed by the outer layer segments 10. It is preferably provided in a further method step that these cavities 11 formed between the inner layer 3, the profile elements 9, 17, and the outer layer segments 10 are foamed. For this purpose, a pressure-resistant and temperature-resistant foam is preferably provided. A polyurethane foam, for example, from HEXCEL, is particularly preferably provided, which withstands temperatures of 200° C. and pressures of up to 10 bar over a limited time. It is preferably provided that the distance between inner layer 3 and outer layer 18 is between 2 cm and 7 cm, in particular between 3 cm and 6 cm, above all essentially approximately 5 cm. The inner layer is protected from mechanical damage, and from alternating thermal strains, by the foaming of the cavities 11. It can thus be achieved that the inner layer 3 does not cool to the low external temperatures of −60° C. and less upon use of a temperature-controlled inner cabin. Therefore, condensing or freezing of the moisture does not occur in the cavities of the inner layer 3, which hardly occur in any case according to the present method, and therefore material fatigue also does not occur. Furthermore, the foam is used for noise insulation.

After the foaming of the cavities 11, it is provided in a further method step that the form 7 is removed from an interior 15 of the hollow body 1. For this purpose, it can be provided that the inner layer 3 is heated to a very limited extent, it being ensured that the inner layer 3 and in particular the first ply 6 do not cure. It is to be achieved by this heating that the inner layer 3 is implemented as sufficiently strong with respect to its static capabilities that it can absorb its intrinsic weight without noticeable deformations, and can be traversed by human workers. It is preferably provided that the hollow body is heated to 120° C. for half an hour, this preferably being performed in that correspondingly preheated air is conducted through the interior of the form. In the above-described preferred implementation of the form 7 comprising silicone-coated glass fiber fabric, a partial vacuum can be produced in the form to remove the form 7, and a gas, such as air, can be injected between the form 7 and the inner layer 3, to support the detachment of the form 7 from the inner layer 3.

After the removal of the form 7 from the interior 15, it is preferably provided in a further method step that specifiable built-ins 12, preferably comprising fiber composite material, are situated in the interior 15 of the hollow body 1, and are connected directly to the inner layer 3, in particular using at least resin-wetted fiber material 5. Through the direct connection of built-ins 12 of the interior 15 to the inner layer 3, these built-ins 12 may absorb or transmit forces themselves as load-bearing parts. For example, the cabin floor or the cargo space floor can already be considered as part of the load-bearing construction of the aircraft fuselage 2 during its planning, for example. The entire aircraft fuselage 2 can thus be constructed still significantly lighter. Furthermore, the possibility exists of connecting seats or luggage compartments directly to the inner layer 3. The safety is increased by this connection, because tearing out of a connector does not have to be a concern. Furthermore, further mass can thus be saved, because current connectors made of metal can be completely dispensed with. It is preferably provided that the inner layer 3 itself already faces toward a passenger compartment unconcealed as the innermost visible surface, whereby further mass can be dispensed with.

In the course of the attachment of built-ins in the interior 3, it is preferably also provided that cable ducts and passages and mounts for hydraulic systems are provided in the built-ins 12, or are provided separately and are connected directly to the inner layer 3. Furthermore, it can be provided that suspensions for the landing gear and/or the wings are connected directly to the inner layer 3, and optionally fuel and/or further liquid tanks are provided and connected to the inner layer 3. Through the preferred implementation of as many of these built-ins 12 as possible comprising fiber material 5, the entire aircraft fuselage 2 can be formed as if from one piece, and does not have potential breakpoints at connection points to subsequently added components. The safety of an aircraft can thus be significantly increased, the mass and the production outlay being able to be reduced simultaneously.

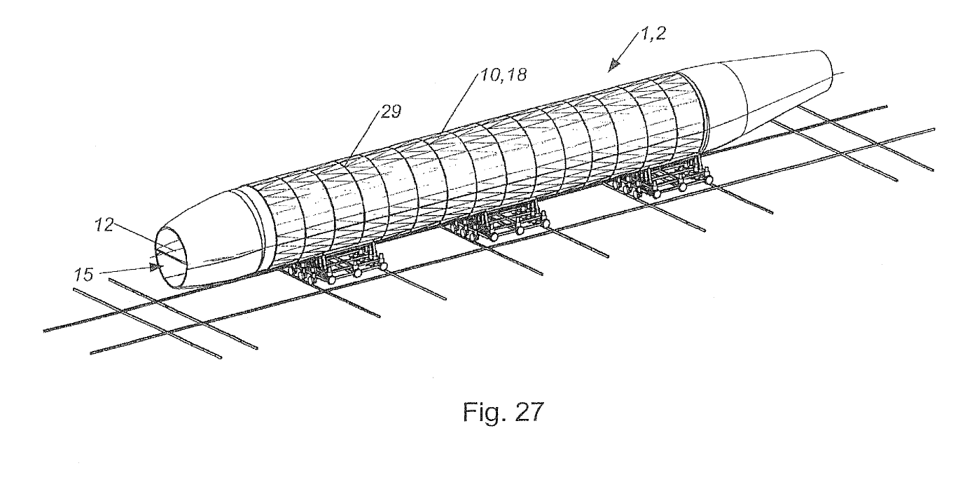

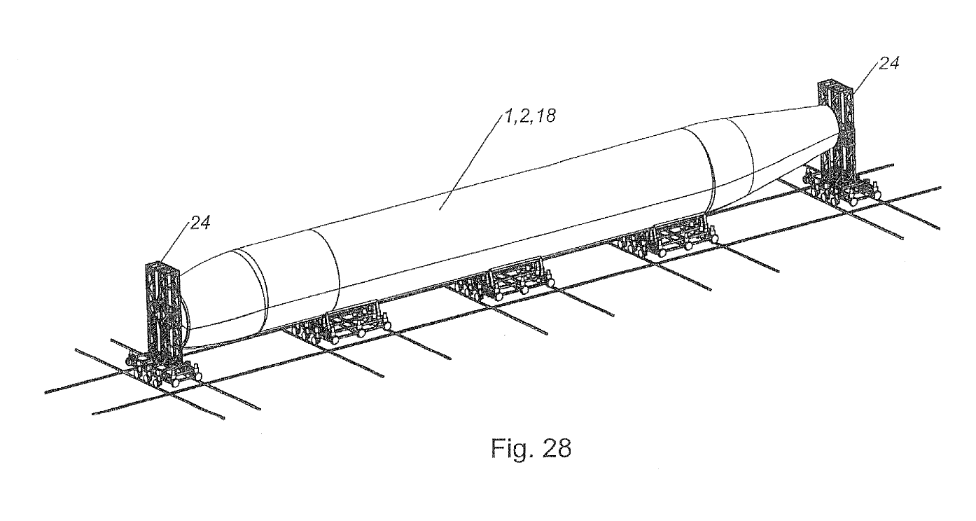

FIG. 27 shows an aircraft fuselage 2, in which the inner built-ins 12 have already been performed, as is recognizable on the cabin floor. However, this fuselage still has the partition lines 29 resulting between the individual outer layer segments 10, which are filled in a further method step. The final lacquering is also completed at this time, in that the filled partition lines 29 are lacquered. FIG. 28 shows a finished aircraft fuselage 2 of this type.

In a next method step, it is provided that the aircraft fuselage 2 is cured, in particular by conducting correspondingly heated air through the interior 15 of the aircraft fuselage 2, this being able to be performed simply by having hot air flow through and/or around the aircraft fuselage 2. It is preferably provided in this case that hot air having a temperature of up to 180° C. is conducted through the interior, a pressure between 10 bar and 20 bar being built up in the interior. So-called press molding thus occurs during the curing. A treatment in an autoclave can be dispensed with, whereby the provision and the operation of an autoclave and possibly the transport of the parts to the autoclave can be dispensed with. The limitation of the component size by the internal dimensions of the autoclave is thus also dispensed with.

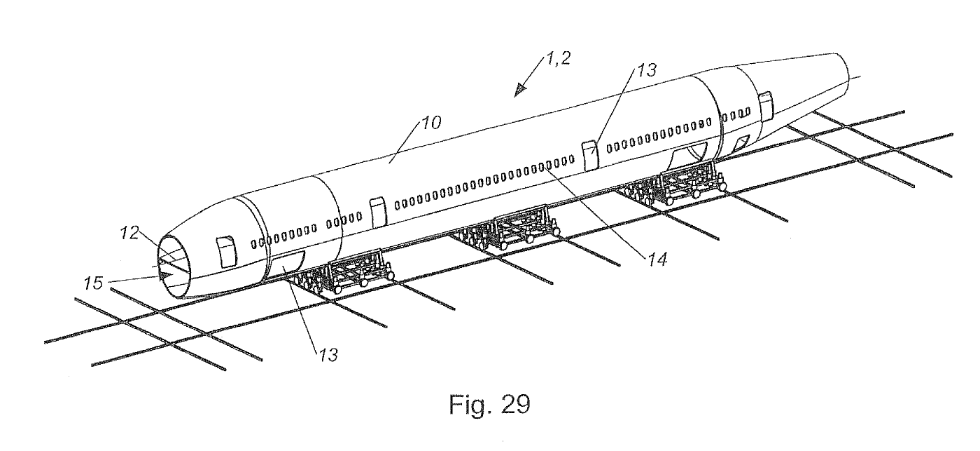

In a further method step, it is provided that—if the hollow body 1 is implemented as an aircraft fuselage 2—door and/or window openings 13, 14 are cut along the correspondingly situated door and/or window profile elements 17 in the aircraft fuselage 2. It is preferably provided that in particular the door openings 13 are cut out of the aircraft fuselage 2 in such a manner that the cut-out parts may already be reused as the door, whereby further material applications can be dispensed with for this purpose. It is preferably provided that the door and/or window openings 13, 14 are cut using lasers. FIG. 29 shows an aircraft fuselage 2 completed in this manner, the attachment areas of the wing also being able to be cut out accordingly.

Further embodiments according to the invention only have a part of the described features, any combination of features, in particular also of various described embodiments, being able to be provided.

While the invention has been illustrated and described in connection with currently preferred embodiments shown and described in detail, it is not intended to be limited to the details shown since various modifications and structural changes may be made without departing in any way from the spirit and scope of the present invention. The embodiments were chosen and described in order to explain the principles of the invention and practical application to thereby enable a person skilled in the art to best utilize the invention and various embodiments with various modifications as are suited to the particular use contemplated.

What is claimed as new and desired to be protected by Letters Patent is set forth in the appended claims and includes equivalents of the elements recited therein:

What is claimed is:

1. A method for producing a hollow body in sandwich construction, comprising the steps of:
forming an inner layer from of a specifiable number of plies of a fiber material which is at least resin-wetted; and
arranging at least a first ply of the inner layer in the shape of a helix and without interruption essentially over an entire length of the hollow body.

2. The method of claim 1, wherein the hollow body is an aircraft fuselage.

3. The method of claim 1, wherein the fiber material includes carbon fibers.

4. The method of claim 1, wherein the inner layer is implemented as essentially a sole load-bearing layer of the sandwich construction, at least peripherally.

5. The method of claim 1, wherein the first ply of the inner layer is applied to a form by rotation of the form around a rotational axis and forward movement of the at least resin-wetted fiber material essentially parallel to the rotational axis of the form.

6. The method of claim 5, wherein the form is rotated continuously.

7. The method of claim 1, wherein a second ply of the inner layer is applied to cross the first ply.

8. The method of claim 1, wherein essentially immediately after application of all plies of the at least resin-wetted fiber material of the inner layer, a specifiable number of profile elements are applied along a longitudinal extension of the hollow body to the inner layer.

9. The method of claim 8, wherein the profile elements include a fiber composite material.

10. The method of claim 8, wherein the profile elements are applied using at least resin-wetted fiber material.

11. The method of claim 8, further comprising the step of arranging a specifiable number of outer layer segments peripherally, which are formfittingly connected to one another.

12. The method of claim 11, wherein the outer layer segments are non-load-bearing segments.

13. The method of claim 11, wherein the outer layer segments are arranged in a longitudinal direction.

14. The method of claim 11, wherein the outer layer segments rest on the profile elements.

15. The method of claim 11, further comprising the step of foaming cavities formed between the inner layer, the profile elements, and the outer layer segments.

16. The method of claim 5, wherein the form is removed from an interior of the hollow body.

17. The method of claim 16, further comprising the steps of arranging specifiable built-ins in the interior of the hollow body, and directly connecting the build-ins to the inner layer.

18. The method of claim 17, wherein the built-ins include fiber composite material.

19. The method of claim 17, wherein the built-ins are connected to the inner layer using at least resin-wetted fiber material.

20. The method of claim 1, further comprising the step of curing the hollow body.

21. The method of claim 20, wherein the hollow body is cured by passing through temperature-controlled air.

22. The method of claim 2, wherein door and/or window openings of the aircraft fuselage are cut along door and/or window profile elements in the hollow body.

23. A hollow body constructed essentially in sandwich construction, comprising an inner layer facing toward an interior of the hollow body and including at least one first ply of fiber composite material, wherein the at least the first ply has a helical configuration and extends without interruption essentially over an entire length of the hollow body.

24. The hollow body of claim 23 for use as aircraft fuselage.

25. The hollow body of claim 23, wherein the fiber composite material includes carbon fibers.

26. The hollow body of claim 23, wherein the inner layer is constructed as essentially a sole load-bearing layer of the sandwich construction at least peripherally.

27. The hollow body of claim 23, further comprising a specifiable number of at least one member selected from the group consisting of profile elements, door profile elements, and window profile elements, for arrangement between the inner layer and an outer layer having an outer contour, said member running along a longitudinal extension of the hollow body.

28. The hollow body of claim 27, wherein the outer layer is formed peripherally by a specifiable number of essentially non-load-bearing outer layer segments, which are formfittingly connected to one another.

29. The hollow body of claim 28, wherein the outer layer extends in the longitudinal extension of the hollow body.

30. A device for producing a fiber material which is at least wetted with resin, said device comprising:
a storage unit for a web of non-wetted fiber material;
at least one vessel for receiving a specifiable quantity of resin; and
an assembly to guide at least a first area of the web from the storage unit in the resin of the vessel to implement a repeated immersion of the web in the resin.

31. The device of claim 30, wherein the assembly includes a specifiable number of deflection rollers, with a first plurality of deflection rollers comprised of every second deflection roller being situated in the vessel in such a manner that the first plurality of deflection rollers is immersed in the resin, and with a second plurality of deflection rollers being situated between the first plurality of deflection rollers outside the resin.
